(19) United States
(12) Patent Application Publication
(10) Pub. No.: US 2020/0009923 A1
(43) Pub. Date: Jan. 9, 2020

(54) VEHICLE WHEEL

(71) Applicant: HONDA MOTOR CO., LTD., Tokyo (JP)

(72) Inventors: Youichi KAMIYAMA, Wako-shi (JP); Toshinobu SAITO, Wako-shi (JP); Yusuke OSAWA, Wako-shi (JP)

(21) Appl. No.: 16/502,358

(22) Filed: Jul. 3, 2019

(30) Foreign Application Priority Data
Jul. 6, 2018 (JP) 2018-128746

(51) Int. Cl. B60C 19/00; B60B 21/12

(52) U.S. Cl. CPC B60C 19/002; B60B 2900/133; B60B 21/12

(57) ABSTRACT

In a vehicle wheel of the present invention, a sub-air chamber member functioning as a Helmholtz resonator includes a main body section forming a sub-air chamber in a space surrounded by a bottom plate adjoined to the outer circumferential surface of a well section and extending in a wheel width direction, an upper plate opposed to the bottom plate at a predetermined interval on an outer side in a wheel radial direction of the bottom plate, and a pair of side plates standing outward in the wheel radial direction from both ends in the wheel width direction of the bottom plate, and a pair of edge sections which extend outward in the wheel width direction from respective joining sections of the bottom plate and the pair of side plates, and which are locked to the well section.

### BACKGROUND OF THE INVENTION

### 1. Field of the Invention

The present invention relates to a vehicle wheel.

### 2. Description of the Related Art

There has been known a wheel in which a Helmholtz resonator (a sub-air chamber member) that muffles air column resonance sound in a tire air chamber is attached to the outer circumferential surface of a well section (see, for example, Japanese Patent No. 4551422 (Patent Literature 1)). The sub-air chamber member of the wheel includes a main body section including a sub-air chamber on the inside and formed long along a wheel circumferential direction, and a pair of tabular edge sections extending in a wheel width direction respectively from both sides of the main body section over substantially the entire length in the longitudinal direction of the main body section. Respective extending distal ends of the edge sections are fitted into groove sections formed in the well section to attach the sub-air chamber member to the well section.

In the sub-air chamber member of such a conventional wheel, a bottom plate in the main body section and the pair of edge sections are together curved at a predetermined curvature such that the sub-air chamber member is be convex to the outer circumferential surface side of the well section. In such a wheel, when a centrifugal force acts on the sub-air chamber member during wheel rotation, the sub-air chamber member tries to rather dent in a direction in which a shape convex to the outer circumferential surface side becomes reversely convex. However, the behavior of the sub-air chamber member trying to rather dent causes a movement of the edge sections applying tension to the groove sections, and further increases a fitting force of the edge sections to the groove sections. That is, with this wheel, as the centrifugal force for peeling off the sub-air chamber member from the well section increases, a retaining force of the sub-air chamber member to the well section is increased.

However, in the conventional wheel (see, for example, Patent Literature 1), the size of the main body section in the wheel width direction is limited by the extending edge sections. Therefore, in the conventional wheel, a large capacity of a sub-air chamber formed in the main body section cannot be secured. Therefore, the conventional wheel is desired to be equipped with a Helmholtz resonator (a sub-air chamber member) that is provided with a large capacity of a sub-air chamber to achieve excellent muffling performance.

### SUMMARY OF THE INVENTION

An object of the present invention is to provide a vehicle wheel including a Helmholtz resonator (a sub-air chamber member) that can secure a larger capacity of a sub-air chamber than the conventional wheel.

According to the present invention, there is provided a vehicle wheel in which a sub-air chamber member functioning as a Helmholtz resonator is attached to an outer circumferential surface of a well section, the sub-air chamber member including: a main body section forming a sub-air chamber in a space surrounded by a bottom plate adjoined to the outer circumferential surface of the well section and extending in a wheel width direction, an upper plate opposed to the bottom plate at a predetermined interval on an outer side in a wheel radial direction of the bottom plate, and a pair of side plates standing outward in the wheel radial direction from both ends in the wheel width direction of the bottom plate; and a pair of edge sections which extend outward in the wheel width direction from respective joining sections of the bottom plate and the pair of side plates, and which are locked to the well section.

According to the present invention, it is possible to provide a vehicle wheel including a Helmholtz resonator (a sub-air chamber member) that can secure a larger capacity of a sub-air chamber than the conventional wheel.

### BRIEF DESCRIPTION OF THE DRAWINGS

FIG. 1 is a perspective view of a vehicle wheel according to an embodiment of the present invention;

FIG. 2 is an overall perspective view of a sub-air chamber member;

FIG. 3 is a sectional view of FIG. 1;

FIGS. 4A to 4C are explanatory diagrams of a process for attaching the sub-air chamber member to a well section;

FIG. 5A is a schematic diagram for explaining action effects obtained by the vehicle wheel according to the embodiment of the present invention; and

FIG. 5B is a schematic diagram of a vehicle wheel in a reference example.

### DETAILED DESCRIPTION OF THE EMBODIMENTS

A vehicle wheel according to an embodiment of the present invention is explained in detail below with reference to the drawings as appropriate. In the drawings referred to below, “X” indicates a wheel circumferential direction, “Y” indicates a wheel width direction, and “Z” indicates a wheel radial direction. The center side in the wheel width direction Y of the outer circumferential surface of a well section in the wheel is sometimes referred to as “inner side in the wheel width direction Y”. A rim flange side in the wheel in the wheel width direction Y is sometimes referred to as “outer side or outward in the wheel width direction Y”.

In the following explanation, the overall configuration of the vehicle wheel is explained first. Then, a sub-air chamber member functioning as a Helmholtz resonator is explained.

### Overall Configuration of the Vehicle Wheel

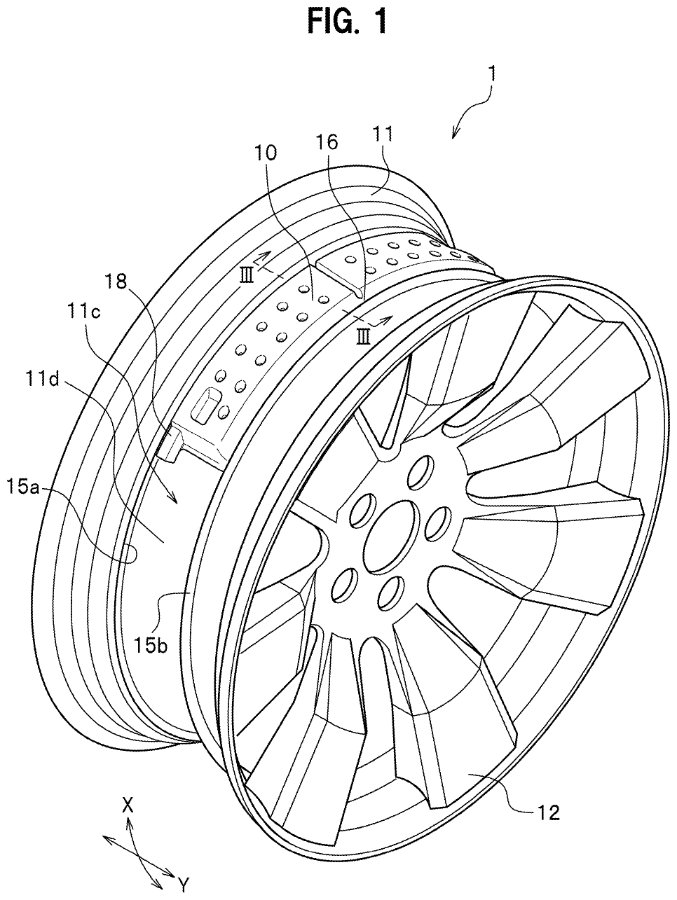

FIG. 1 is a perspective view of a vehicle wheel 1 according to the embodiment of the present invention.

As shown in FIG. 1, the vehicle wheel 1 according to this embodiment is configured by attaching a sub-air chamber member (a Helmholtz resonator) made of synthetic resin such as polypropylene or polyamide to a rim 11 made of metal such as an aluminum alloy or a magnesium alloy.

In FIG. 1, reference numeral 12 denotes a disk for coupling the rim 11 to a not-shown hub.

The rim 11 includes a well section 11c recessed toward a wheel axis side in the wheel radial direction Z between not-shown bead sheets respectively formed at both end portions in the wheel width direction Y. An outer circumferential surface 11d of the well section 11c defined by a bottom surface of the recess have substantially the same diameter with the wheel axis centered over the wheel width direction Y.

The rim 11 in this embodiment includes a standing section 15a standing toward a rim flange side from the outer circumferential surface 11d of the well section 11c on one side in the wheel width direction Y and a bulging section 15b bulging outward in the wheel radial direction Z in the middle of the wheel width direction Y in the outer circumferential surface 11d.

The standing section 15a and the bulging section 15b annularly extend in the wheel circumferential direction X.

### Sub-Air Chamber Member

The sub-air chamber member 10 is explained.

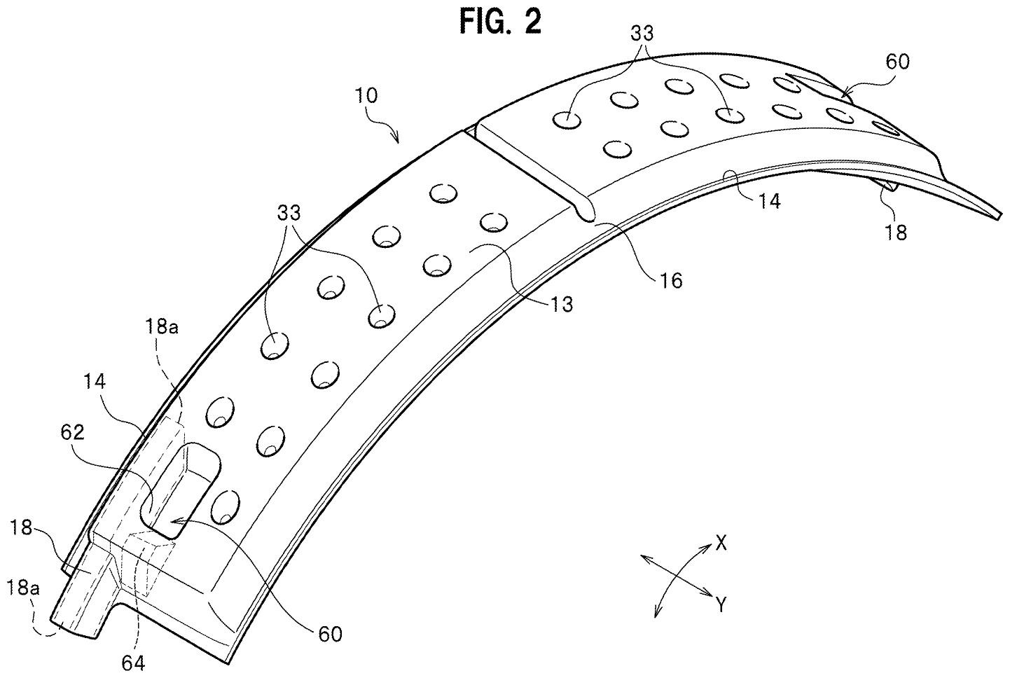

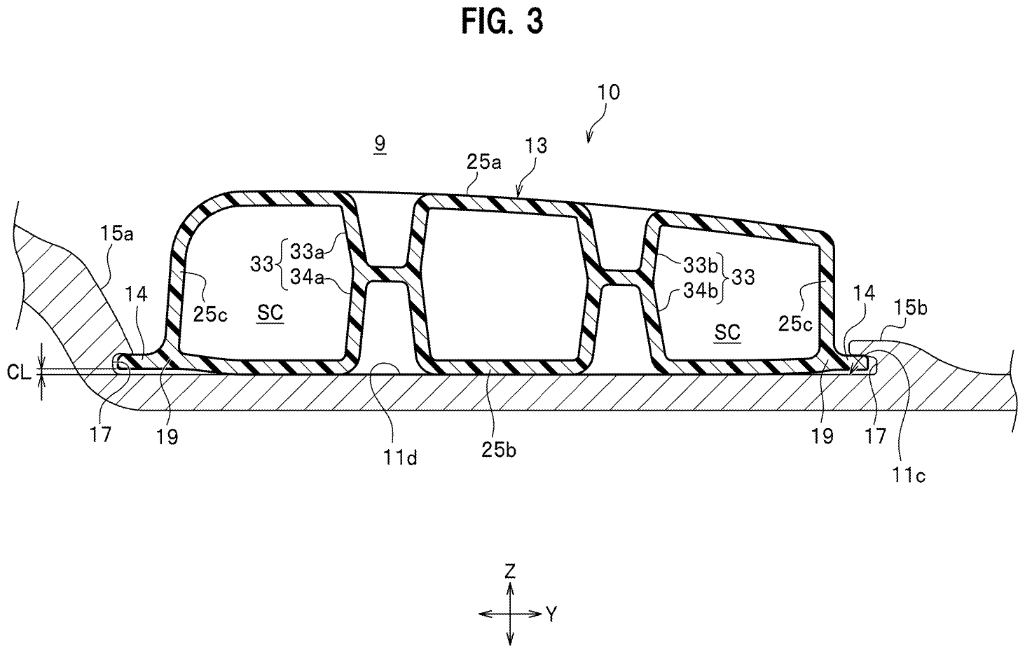

FIG. 2 is an overall perspective view of the sub-air chamber member 10. FIG. 3 is a III-III sectional view of FIG. 1.

As shown in FIG. 2, the sub-air chamber member 10 is a member long in one direction and includes a main body section 13, a tube body 18, and edge sections 14. The sub-air chamber member 10 is configured to be formed in a symmetrical shape in the wheel circumferential direction X with respect to a partition wall 16 extending in the wheel width direction Y in the center of the main body section 13.

The main body section 13 is curved in the longitudinal direction of the main body section 13. That is, the main body section 13 extends along the wheel circumferential direction X when the sub-air chamber member 10 is attached to the outer circumferential surface 11d (see FIG. 1) of the well section 11c (see FIG. 1).

The main body section 13 is hollow on the inside. This hollow section (not shown in FIG. 2) forms a sub-air chamber SC (see FIG. 3) explained below. The hollow section is divided into two in the wheel circumferential direction X by the partition wall 16.

As shown in FIG. 3, the main body section 13 assumes a substantially rectangular shape long in the wheel width direction Y in a sectional view orthogonal to the longitudinal direction (the wheel circumferential direction X in FIG. 2).

Specifically, the main body section 13 includes a bottom plate 25b adjoined to the outer circumferential surface 11d of the well section 11c and extending in the wheel width direction Y, an upper plate 25a opposed to the bottom plate 25b on the outer circumferential surface 11d, and a pair of side plates 25c standing from both ends in the wheel width direction Y of the bottom plate 25b and joined to the upper plate 25a.

The bottom plate 25b is formed by a plate body extending to be substantially flat in the wheel width direction Y. The bottom plate 25b is formed to curve at substantially the same curvature as the curvature of the outer circumferential surface 11d in the wheel circumferential direction X (see FIG. 1).

The upper plate 25a is curved at a predetermined curvature in the wheel circumferential direction X (see FIG. 1) to be opposed to the bottom plate 25b at a predetermined interval.

The side plates 25c are formed to stand from the bottom plate 25b outward in the wheel radial direction Z substantially perpendicularly to the outer circumferential surface 11d of the well section 11c.

The upper plate 25a, the bottom plate 25b, and the side plates 25c are formed to surround the sub-air chamber SC inside the main body section 13.

In the main body section 13, as shown in FIG. 2, a plurality of bridges 33 are formed side by side at equal intervals in the wheel circumferential direction X. The bridges 33 are arranged in two rows in the wheel width direction Y.

As shown in FIG. 3, the bridge 33 is formed by joining an upper combining section 33a and a lower combining section 33b in a position substantially in the center between the upper plate 25a and the bottom plate 25b.

The upper combining section 33a is formed by partially recessing the upper plate 25a toward the bottom plate 25b side. The lower combining section 33b is formed by partially recessing the bottom plate 25b toward the upper plate 25a side.

The bridge 33 assumes a substantially columnar shape and partially couples the upper plate 25a and the bottom plate 25b. The bridge 33 forms openings circular in a plan view in positions corresponding to each other in the up-down direction of the main body section 13.

The tube body 18 (see FIG. 1) is explained.

As shown in FIG. 1, the tube body 18 is formed to project in the wheel circumferential direction X from the main body section 13 in a position displaced to one side in the wheel width direction Y in the main body section 13.

The sub-air chamber member 10 in this embodiment is formed in the symmetrical shape in the wheel circumferential direction X with respect to the partition wall 16. Therefore, although only one tube body 18 is shown in FIG. 1, in this embodiment, a pair of tube bodies 18 is disposed in positions symmetrical to each other at both end portions in the longitudinal direction of the main body section 13 (the wheel circumferential direction X). The pair of tube bodies 18 in this embodiment is disposed in positions separated at an interval of approximately 90° from each other centering on the wheel axis.

As shown in FIG. 2, a communication hole 18a is formed inside the tube body 18.

The communication hole 18a extends from the inside of the tube body 18 to the inside of the main body section 13. The communication hole 18a extending in the main body section 13 is formed by partially partitioning the hollow section of the main body section 13 with the partition wall 62. The partition wall 62 in this embodiment is formed by a recessed section 60 formed to recess from the upper plate 25a side toward the bottom plate 25b side and a recessed section 64 formed to recess from the bottom plate 25b side toward the upper plate 25a side.

The communication hole 18a causes the sub-air chamber SC (see FIG. 3) formed on the inside of the main body section 13 and a tire air chamber 9 (see FIG. 3) formed between the sub-air chamber member 10 and a tire (not shown in FIG. 3) on the well section 11c (see FIG. 3) to communicate.

The edge sections 14 (see FIG. 3) are explained.

As shown in FIG. 3, the edge sections 14 are formed by plate bodies extending outward in the wheel width direction from both ends in the wheel width direction Y of the bottom plate 25b.

In other words, the edge sections 14 extend along an extending direction of the bottom plate 25b from joining sections 19 of the bottom plate 25b and the side plates 25c. That is, the edge sections 14 extend substantially in parallel to the outer circumferential surface 11d of the well section 11c.

The thickness of the edge sections 14 in this embodiment is set to substantially the same thickness as the thickness of the upper plate 25a, the bottom plate 25b, and the side plates 25c. The edge sections 14 are elastically deformed by selecting the thickness and the material of the edge sections 14 as appropriate.

Extending distal ends of the edge sections 14 are fitted into groove sections 17 respectively formed in the standing section 15a and the bulging section 15b.

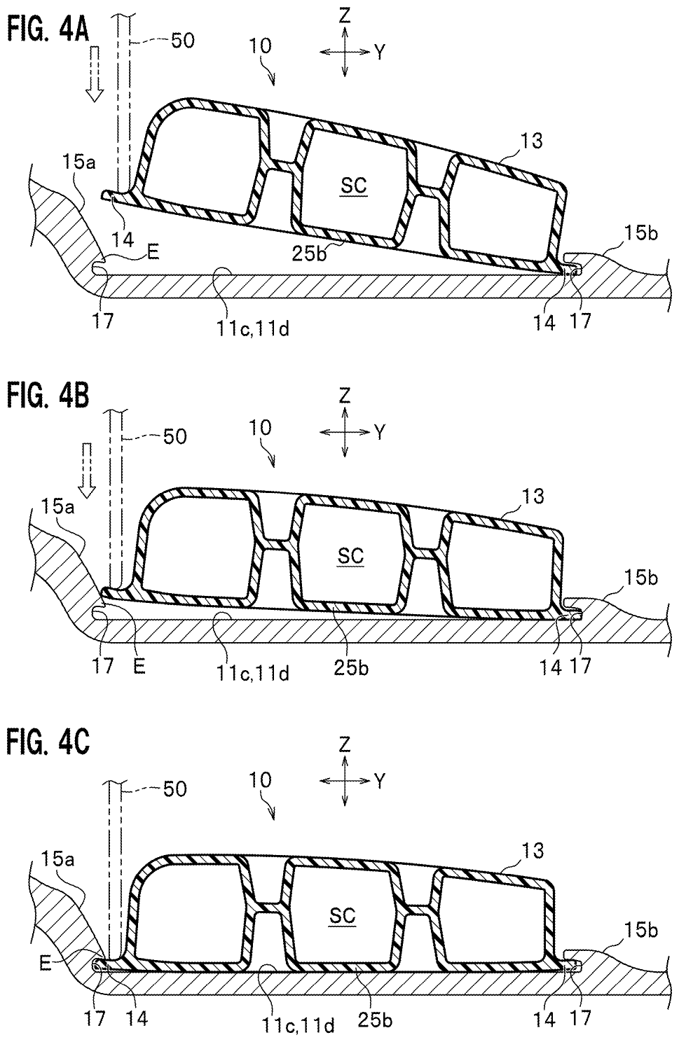

The groove sections 17 are respectively opened on sides where the standing section 15a and the bulging section 15b face each other. An opening width of the groove sections 17 in this embodiment is set to width obtained by adding, to the thickness of the bottom plate 25b, clearance CL equal to a displacement width of the edge sections 14 when being fitted into the groove sections 17 in a process for attaching the sub-air chamber member 10 to the well section 11c explained below (see FIG. 4). The clearance CL in this embodiment is height from the outer circumferential surface 11d of the well section 11c to a lower part of the edge sections 14 and is assumed to be approximately 0.5 mm to 1.0 mm. However, the clearance CL is not limited to this.

Respective extending ends of the edge sections 14 are fitted into and locked in the groove sections 17 on an extended line of the bottom plate 25b in the wheel width direction Y.

The sub-air chamber member 10 according to this embodiment explained above is assumed to be a resin molded product. However, the sub-air chamber member 10 is not limited to this and can also be formed by another material such as metal. When the sub-air chamber member 10 is made of resin, blow-moldable resin light in weight and having high rigidity is desirable when a reduction in weight, improvement of mass productivity, and a reduction of manufacturing cost of the sub-air chamber member 10, securing of airtightness of the sub-air chamber SC, and the like are considered. Above all, polypropylene, polyamide, and the like are desirable.

### Method of Attaching the Sub-Air Chamber Member

A method of attaching the sub-air chamber member 10 to the well section 11c is explained. FIGS. 4A to 4C are process explanatory diagrams for explaining the method of attaching the sub-air chamber member 10 to the well section 11c.

As shown in FIG. 4A, in the method of attaching the sub-air chamber member 10, it is assumed that a pusher (a pressing device) 50 that presses the sub-air chamber member 10 toward the outer circumferential surface 11d of the well section 11c is used.

Examples of the pusher 50 include a pusher that generates a pressing force with an air pressure of an air cylinder.

In FIGS. 4A to 4C, the pusher 50 is indicated by an imaginary line (an alternate long and short two dashes line) for convenience of drawing figures.

Examples of the pusher 50 used in this embodiment include a tabular member including an edge portion having an arcuate contour conforming to a curvature in the longitudinal direction of the sub-air chamber member 10 (the wheel circumferential direction X in FIG. 2). The pusher 50 applicable to the present invention is not limited to this. Design of the pusher 50 can be changed as appropriate.

In this attaching method, as shown in FIG. 4A, first, the sub-air chamber member 10 is tilted and the edge section 14 is fitted into the groove section 17 of the bulging section 15b.

The pusher 50 is pressed against the edge section 14 on the opposite side of the edge section 14 into which the groove section 17 is fitted. A load is applied in a white arrow direction.

Consequently, as shown in FIG. 4B, the sub-air chamber member 10 approaches the outer circumferential surface 11d of the well section 11c. The edge section 14, against which the pusher 50 is pressed, comes into contact with an edge portion E formed right above the groove section 17 of the standing section 15a. The edge section 14 bends with reaction received from the edge portion E.

Subsequently, as shown in FIG. 4C, the edge section 14 is fitted into the groove section 17 of the standing section 15a by the pusher 50. Then, the bottom plate 25b of the main body section 13 is adjoined to the outer circumferential surface 11d of the well section 11c. A series of processes of the attaching method ends.

Action effects obtained by the vehicle wheel 1 in this embodiment are explained.

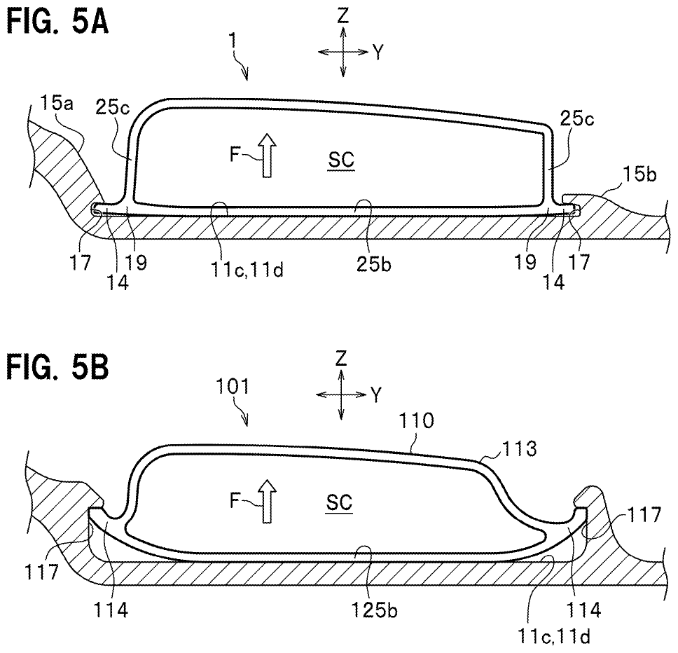

FIG. 5A is a schematic diagram for explaining action effects obtained by the vehicle wheel 1 according to the embodiment of the present invention. FIG. 5B is a schematic diagram of a vehicle wheel 101 in a reference example.

The configuration of the wheel 101 in the reference example is explained.

As shown in FIG. 5B, a sub-air chamber member 110 of the wheel 101 in the reference example includes a main body section 113 and a pair of edge sections 114 formed by plate bodies extending in the wheel width direction Y from the main body section 113. Extending distal ends of the edge sections 114 are fitted into and locked in groove sections 117 formed in the well section 11c.

In the sub-air chamber member 110 in the reference example, a bottom plate 125b in the main body section 113 to the pair of edge sections 114 are together curved at a predetermined curvature such that the sub-air chamber member 110 is convex to the outer circumferential surface 11d side of the well section 11c. In the wheel 101, when a centrifugal force F acts on the sub-air chamber member 110 during wheel rotation, the wheel 101 tries to rather dent in a direction in which a shape convex to the outer circumferential surface side becomes reversely convex.

Such a behavior of the sub-air chamber member 110 trying to rather dent a movement of the edge sections 114 applying tension to the groove sections 117, and further increases a fitting force of the edge sections 114 to the groove sections 117. That is, with this wheel 101, as the centrifugal force F for peeling off the sub-air chamber member 110 from the well section 11c increases, a retaining force of the sub-air chamber member 110 to the well section 11c is increased.

However, in the wheel 101, the size of the main body section 113 in the wheel width direction Y is limited by the extending edge sections 114. Therefore, in the wheel 101, the capacity of the sub-air chamber SC formed in the main body section 113 is also limited.

On the other hand, in the sub-air chamber member 10 of the vehicle wheel 1 according to this embodiment, as shown in FIG. 5A, the bottom plate 25b is adjoined to the outer circumferential surface 11d of the well section 11c and extends in the wheel width direction Y. The edge sections 14 extend outward in the wheel width direction Y from the joining sections 19 of the bottom plate 25b and the side plates 25c and locked to the well section 11c.

With the vehicle wheel 1, since the bottom plate 25b is adjoined to the outer circumferential surface 11d and extends, unlike the sub-air chamber member 110 (see FIG. 5B) including the curved bottom plate 125b (see FIG. 5B) in the reference example, it is possible to secure a large capacity of the sub-air chamber SC.

The vehicle wheel 1 including the sub-air chamber member 10 is more excellent in muffling performance for load noise.

In the vehicle wheel 1, the edge sections 14 extend outward in the wheel width direction Y from the joining sections 19 of the bottom plate 25b and the side plates 25c to extend to the respective groove sections 17 of the standing section 15a and the bulging section 15b along the outer circumferential surface 11d of the well section 11c.

That is, the edge sections 14 in this embodiment linearly extending toward the groove sections 17 can be set to have a shorter extending length than the edge sections 114 (see FIG. 5B) in the reference example that curve and extend toward the groove sections 117 (see FIG. 5B).

Consequently, when the centrifugal force F acts on the sub-air chamber member 10, a bending amount of the edge sections 14 in this embodiment can be reduced. Therefore, with the vehicle wheel 1, it is possible to increase a retaining force of the sub-air chamber member 10 to the well section 11c when the centrifugal force F is applied.

Since the extending length of the edge sections 14 (see FIG. 5A) is set short, in the vehicle wheel 1 (see FIG. 5A), the respective side plates 25c can be disposed near the standing section 15a and the bulging section 15b. Consequently, in the vehicle wheel 1, the capacity of the sub-air chamber SC (see FIG. 5A) can be increased.

In the vehicle wheel 1 in this embodiment, the respective extending ends of the pair of edge sections 14 are fitted into and locked in the groove sections 17 formed in the well section 11c.

With the vehicle wheel 1, it is possible to further increase the retaining force of the sub-air chamber member 10 to the well section 11c when the centrifugal force F is applied.

Since the edge sections 14 of the sub-air chamber member 10 can be set short as explained above, the edge sections 14 can be fitted into, with a slight bending amount, the groove sections 17 provided on an extended line of the outer circumferential surface 11d of the well section 11c. That is, with the vehicle wheel 1, it is possible to more easily and surely form a structure in which the bottom plate 25b is adjoined to the outer circumferential surface 11d.

The embodiment is explained above. However, the present invention is not limited to the embodiment and can be carried out in various forms.

In the embodiment, the vehicle wheel 1 is explained in which the outer circumferential surface 11d of the well section 11c has substantially the same diameter with the wheel axis centered over the wheel width direction Y. However, the present invention can adopt a configuration in which the diameter of the outer circumferential surface 11d changes over the wheel width direction Y. That is, in the vehicle wheel 1, as long as the bottom plate 25b is formed along the outer circumferential surface 11d, the outer circumferential surface 11d may incline with respect to the wheel axis and/or partially curve in a sectional view crossing the wheel circumferential direction X.

What is claimed is:

1. A vehicle wheel in which a sub-air chamber member functioning as a Helmholtz resonator is attached to an outer circumferential surface of a well section,
the sub-air chamber member comprising:
a main body section which forms a sub-air chamber in a space surrounded by a bottom plate adjoined to the outer circumferential surface of the well section and extending in a wheel width direction, an upper plate opposed to the bottom plate at a predetermined interval on an outer side of the bottom plate in a wheel radial direction, and a pair of side plates standing outward in the wheel radial direction from both ends in the wheel width direction of the bottom plate; and
a pair of edge sections which extend outward in the wheel width direction from respective joining sections of the bottom plate and the pair of side plates, and which are locked to the well section.

2. The vehicle wheel according to claim 1, wherein respective extending ends of the pair of edge sections are fitted into and locked in groove sections formed in the well section.
